(19) United States
(12) Patent Application Publication
(10) Pub. No.: US 2025/0043765 A1
(43) Pub. Date: Feb. 6, 2025

(54) VORTEX GENERATOR FOR THE PROXIMAL END REGION OF A HAWT ROTOR BLADE

(71) Applicant: ANAKATA WIND POWER RESOURCES LTD, Oxford (GB)

(72) Inventor: Ben David WOOD, Oxford (GB)

(21) Appl. No.: 18/723,561

(22) PCT Filed: Dec. 9, 2022
(86) PCT No.: PCT/GB2022/053167

§ 371 Date: Jun. 24, 2024

(30) Foreign Application Priority Data
Dec. 22, 2021 (GB) 2118808.1

(51) Int. Cl. F03D 1/06

(52) U.S. Cl. CPC F03D 1/06495; F03D 1/0641

(57) ABSTRACT

A vortex generator 10, 10′ is arranged oblique to the flow direction DF on the surface 8 of the radially inward portion 1 of a HAWT rotor blade. The vortex generator has an upwardly stepped free edge 12 and defines, proximate its trailing end 14, a lower convexity 23 opposite a lower concavity 23′, and an upper convexity 24 opposite an upper concavity 24′. The upper and lower concavities 24′, 23′ open at opposite sides 15, 16 of the vortex generator.

This invention relates to vortex generators as used on lift-based rotor blades on horizontal axis wind turbines (HAWTs), and particularly to vortex generators for use on the proximal (radially inward) end region of the blade.

Vortex generators are typically small, triangular projections which are mounted on aerofoils to mix faster flowing air into the boundary layer at the blade surface so as to mitigate stalling, for example, where the aerofoil has suboptimal geometry or operating conditions. Stalling means the separation of the high speed airflow from the surface of the aerofoil in advance of the trailing edge, resulting in a loss of lift and increased drag.

Most modern commercial wind generators (i.e. wind turbines that generate electricity) are HAWTs with lift-based rotors—which is to say, the rotor blades are aerofoils which rotate about the rotor axis at a tip speed higher than the wind speed, typically with a tip speed ratio of around 8 to 10. The air flowing over the aerofoil generates lift (a force normal to the direction of the relative wind, i.e. the mean direction of the air impinging on the blade as it rotates), which drives the rotor in rotation.

The blade of a HAWT rotor extends radially outwardly away from the rotor axis along a blade length axis from the root of the blade at the rotor hub to the tip. As the radial distance from the hub increases, the tangential speed of the blade also increases and so the direction of the relative airflow moves progressively away from the direction of the wind (which flows through the rotor along its axis of rotation) to oppose the rotational direction of the blade. For this reason, the blade is twisted along its length axis, with the leading edge turning progressively towards the direction of rotation with increasing distance from the hub, to maintain an optimal angle of attack (the angle of the chord of the aerofoil relative to the airflow).

The aerofoil profile is shaped to generate a pressure differential between the downwind (lower pressure or “suction”) side of the blade and the upwind (higher pressure or “pressure”) side of the blade, with a chord length defined as a straight line between the leading and trailing edge points in a plane perpendicular to the blade length axis. The pressure differential across the blade appears as a force acting on the blade in a direction perpendicular to the direction of the relative airflow, referred to as lift. The lift force includes a thrust component, which acts along the direction of the axis of rotation, and a torque component which urges the blades in the direction of rotation and is converted into shaft power at the rotation axis. Thrust must be reacted by the hub and supporting structures and so increases capital cost. The angle of attack is therefore selected to maximise torque relative to thrust.

The air flowing over the blades gives rise to reaction forces, referred to collectively as drag, which act on the blades in a direction opposed to the direction of rotation. Drag includes: induced drag, which results from the deflection of the air flowing over the blade and so may be regarded as the counterpart of lift; and parasitic drag, which includes skin friction as the air flows over the surface of the blade. Drag consumes some of the useful torque and thus reduces the output shaft power of the rotor.

As the blades rotate, the pressure differential across the upwind and downwind sides of each blade causes the air to flow around the blade from the higher pressure, upwind side to the lower pressure, downwind side. Most of the flow is along the direction of the chord, i.e. in the width direction of the blade, from its leading edge to its trailing edge, hence contributing to generate the pressure differential which produces the lift and hence the torque which drives the blade in rotation.

A smaller component of the flow is along the length direction of the blade, radially outwardly away from the hub towards the tip, and around the tip of the blade from the higher pressure, upwind side to the lower pressure, downwind side. This flow reduces the differential pressure across the upstream and downstream sides of the blade and hence reduces lift in the region near the blade tip. The air is shed from the blade tip to form a tip vortex which trails behind the blade and consumes some of the rotational energy of the rotor, thus contributing to induced drag.

The commercial case for a wind turbine installation depends largely on its mass efficiency, which is to say, its average output shaft power relative to the mass moment of inertia of the rotor.

HAWT blades represent a compromise between aerodynamic and structural objectives. By extending the chord proximate the blade root it would be possible to form the entire blade with an optimal aerofoil profile, and so to obtain additional lift. However, this would result in a disproportionate reduction in mass efficiency and increase in thrust. A typical HAWT blade will therefore have a profile that is circular at the blade root where it connects to the rotor hub, gradually blending into an optimal aerofoil profile as it moves away from the root towards the tip.

As air flows over the aerofoil a boundary layer is formed, which clings to the aerofoil while the faster airstream flows over the boundary layer. The low Reynolds number and aerodynamically suboptimal profile in the radially inward portion of a HAWT blade proximate the root produce a thickened boundary layer and a high propensity to stall.

The present applicant has observed that conventional vortex generators mounted in this region of the blade tend to produce a single vortex which detaches from the blade surface well in advance of the trailing edge, allowing a thick boundary layer to form behind it.

Accordingly, it is a general object of the present invention to provide a vortex generator that performs better when mounted in the proximal end region of a lift-based HAWT rotor blade.

Accordingly the invention provides: in a first aspect, a vortex generator as defined in claim 1; and in a second aspect, a HAWT rotor blade having a proximal end portion with an array of such vortex generators spaced apart along the blade length axis. The dependent claims define optional features.

Each vortex generator (hereinafter VG) is configured to be mounted in a use position on the blade, which forms part of the rotor of a horizontal axis wind turbine (hereinafter HAWT). The blade has a blade length axis and a blade surface and defines an aerofoil profile which is configured to generate lift when the rotor rotates about the rotor axis so that air flows over the blade surface in a nominal flow direction, perpendicular to the blade length axis. The blade extends in use radially outwardly from the rotor axis along the blade length axis, from the proximal end portion terminating at the blade root at the hub, to a distal end portion terminating at the blade tip.

The VG has a lower margin, an upper margin, and a height in a height dimension between the blade surface and the upper margin when mounted in the use position.

The VG also has a leading end, a trailing end, and a length in a length dimension between the leading end and the trailing end.

The VG also has a pressure side, a suction side opposite the pressure side, and a thickness in a thickness dimension between the pressure side and the suction side, each of the pressure side and the suction side being bounded in the height dimension by the lower margin and the upper margin.

When mounted in the use position, the leading end is upstream of the trailing end in the flow direction, and the lower margin is arranged at the blade surface for at least a part of the length.

In the use position, the VG extends in the length dimension oblique to the flow direction with the pressure side facing against the flow direction so that, in use, the flowing air impinges on the pressure side; and the upper margin defines at least one step spaced apart in the length dimension from the leading and trailing ends, so that the height of the VG increases stepwise at the or each step towards the trailing end in the length dimension.

When considered in cross-section in a reference plane perpendicular to the blade surface and proximate the trailing end, the VG defines an upper portion terminating at the upper margin, a lower portion terminating at the lower margin, and an intermediate portion between the upper and lower portions.

The lower and intermediate portions define a lower convexity opposite a lower concavity, while the upper and intermediate portions define an upper convexity opposite an upper concavity. The upper and lower concavities open at different sides of the vortex generator.

In use, it is found that a cushion of pressurised air will tend to develop in the concavity opening at the pressure side of the VG, while a reduced pressure develops in the concavity opening at the suction side of the VG. The pressure differential between the two concavities causes the airflow impinging on the pressure side to roll over the upper margin and curl down towards the surface of the blade on the suction side of the VG, thus initiating a vortex which penetrates the boundary layer close to the blade surface.

It is found that a single vortex formed in this way will tend to disintegrate into turbulent flow close to its origin and before reaching the trailing edge of the blade.

By forming the vortex generator with a progressively upwardly stepped upper margin in the flow direction, multiple vortices are generated, one at each step and one at each of the leading and trailing ends. Preferably the upper margin is formed with one, two or three steps, resulting in a family of vortices, which bind together as they flow away from the vortex generator. For reasons not fully understood, it is found that this bound group of vortices tends to remain intact and attached to or closely proximate the blade surface for most or all of the distance to the trailing edge, whereas a single vortex does not.

By placing an array of vortex generators proximate the line at which the fast moving airstream tends to separate from the blade, this behaviour is found to effectively energise the boundary layer and so prevent stalling over a large proportion of the remaining width of the blade.

Further features and advantages will be appreciated from the illustrative embodiments of the invention which will now be described, purely by way of example and without limitation to the scope of the claims, and with reference to the accompanying drawings, in which:

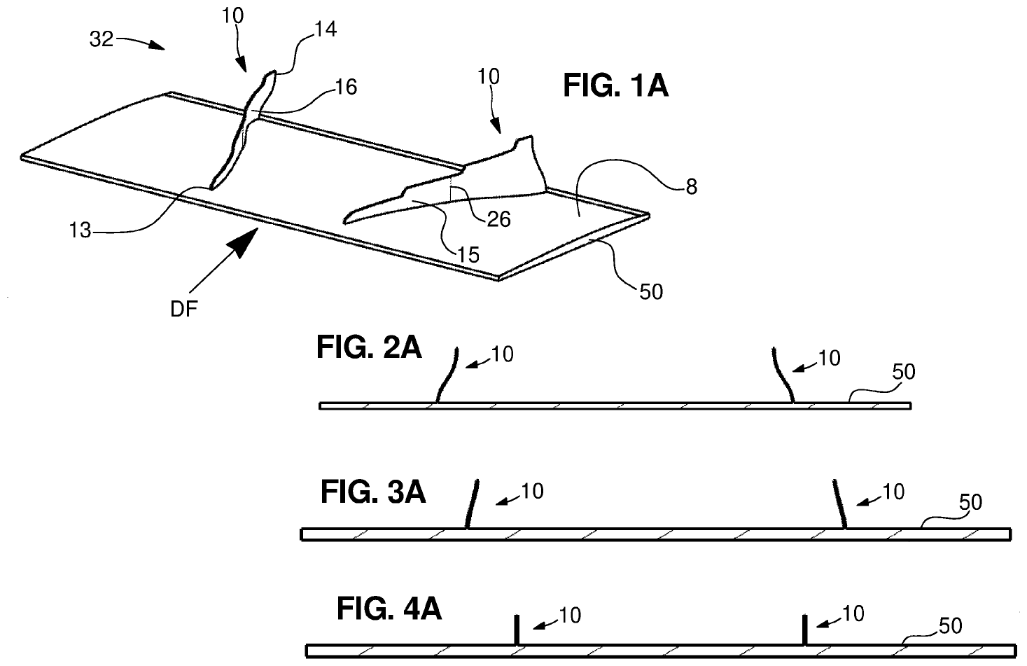

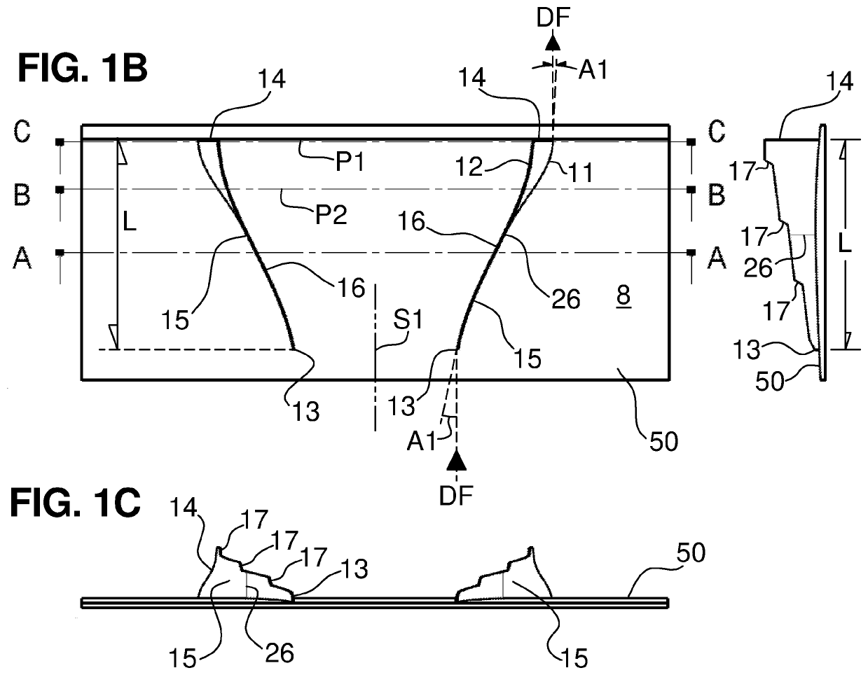

FIG. 1A is shows a diverging pair of first vortex generators mounted on a baseplate, in oblique view.

FIG. 1B shows the pair of first vortex generators in plan and side view.

FIG. 1C shows the pair of first vortex generators in leading end view.

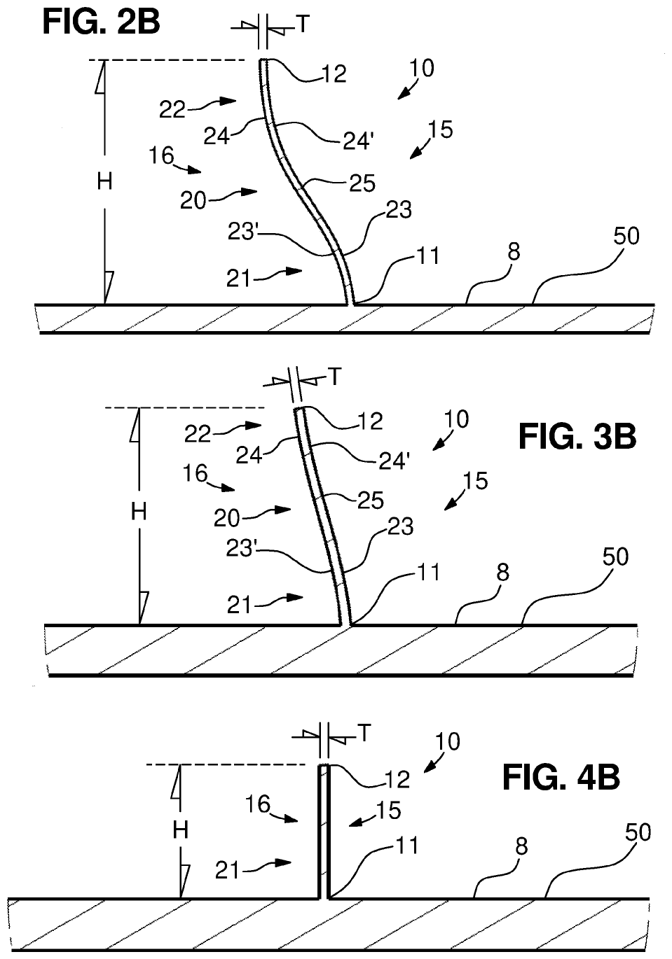

FIG. 2A is a cross-section through the pair of first vortex generators, taken in a first reference plane P1 proximate the trailing end at C-C in the plan view of FIG. 1B.

FIG. 2B is an enlarged view of one of the first vortex generators as shown in FIG. 2A.

FIG. 3A is a cross-section through the pair of first vortex generators, taken in a second reference plane P2 proximate the trailing end at B-B in the plan view of FIG. 1B.

FIG. 3B is an enlarged view of one of the first vortex generators as shown in FIG. 3A.

FIG. 4A is a cross-section through the pair of first vortex generators, taken at A-A in the plan view of FIG. 1B.

FIG. 4B is an enlarged view of one of the first vortex generators as shown in FIG. 4A.

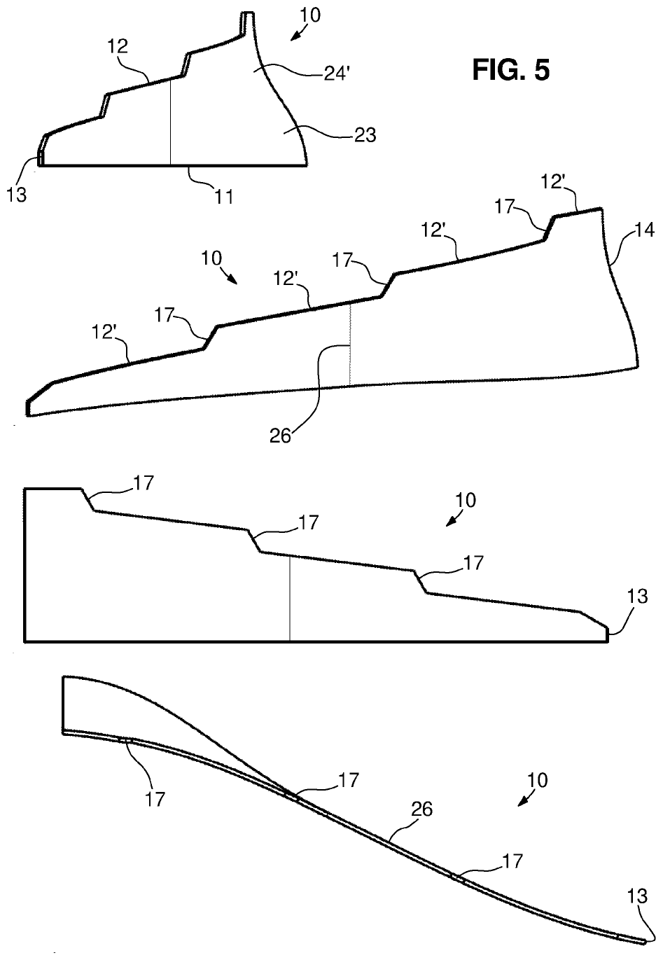

FIG. 5 shows further front, oblique, side and plan views of one of the first vortex generators.

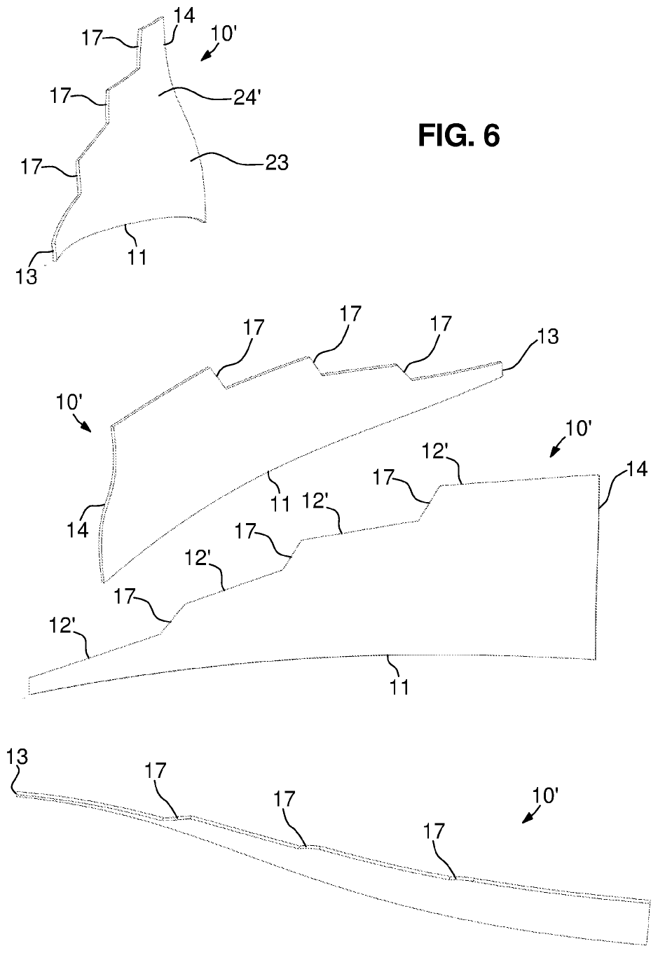

FIG. 6 shows front, oblique, side and plan views of a second, larger, variant vortex generator.

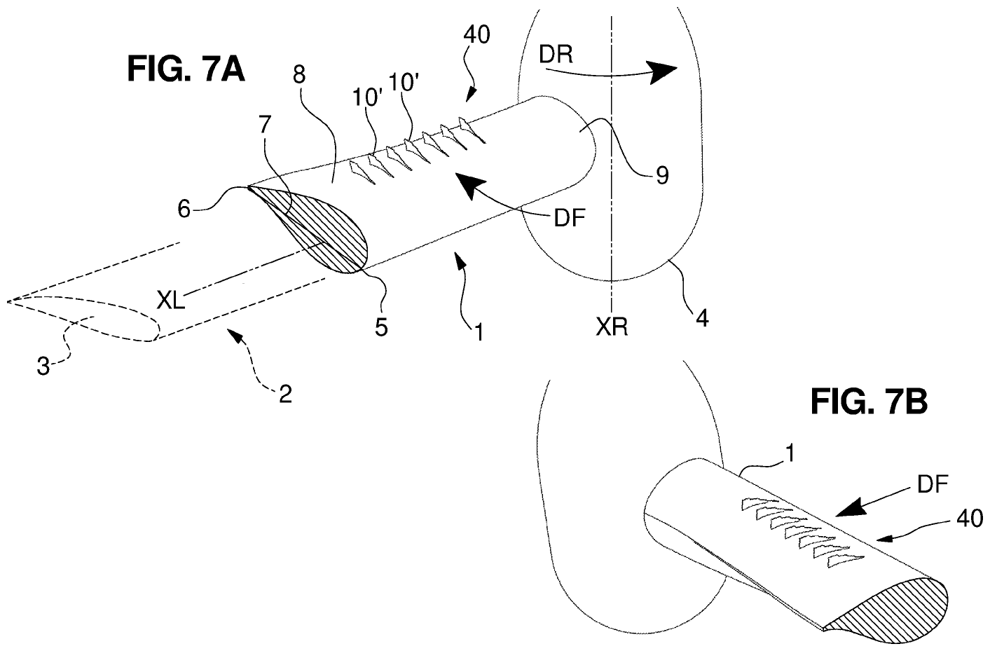

FIGS. 7A and 7B are front and rear views of the proximal end region of a HAWT rotor blade equipped with an array of second vortex generators as shown in FIG. 6.

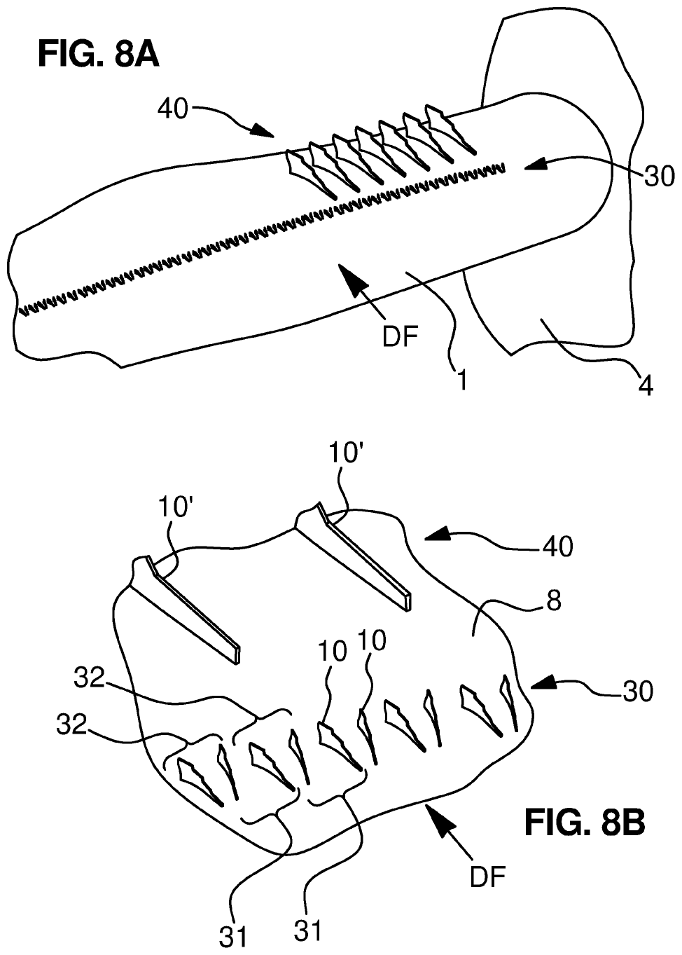

FIG. 8A shows the proximal end region of another HAWT rotor blade equipped with two groups of first and second vortex generators.

FIG. 8B is an enlarged detail view of part of FIG. 8A.

Reference numerals or characters that appear in more than one of the figures indicate the same or corresponding features in each of them.

Referring to FIGS. 7A, 7B, 8A and 8B, a HAWT rotor rotates in use about a rotor axis XR at the hub 4. Each of one or more blades (typically, three blades) is fixed to the hub 4 to extend radially outwardly from the rotor axis XR along the blade length axis XL, from a proximal end region 1 terminating at the blade root 9 to a distal end region 2 terminating at the blade tip 3. Each blade has a blade surface 8 defining an aerofoil profile (best see in section in FIGS. 7A and 7B) which is configured to generate lift when air flows over the blade surface 8 in a nominal flow direction DF perpendicular to the blade length axis XL. The flow direction DF is taken to be generally along the chord 7 and opposite to the direction of rotation DR of the rotor 4, and defines the general direction of the airflow in use.

The chord 7 is defined as an imaginary straight line extending through the profile between a leading edge point 5 and a trailing edge point 6 in the direction of rotation DR; the length of the chord 7 between these points 5, 6 being referred to herein as the chord length of the profile. The blade length axis XL may be defined along the length of the blade at a point 30% of the length of the chord 7 from the leading edge point 5.

In use, a plurality of vortex generators 10, 10′ are mounted on the blade surface 8 and spaced apart along the blade length axis XL (which is to say, along the length direction of the blade) to form an array on the proximal end region 1 of the blade. Preferably the blade is first tested as known in the art (e.g. in the field or wind tunnel, or by CFD modelling) to determine the position of the line along which stalling is likely to occur, which is to say, where the faster airflow tends to detach from the blade surface. The vortex generators 10 are then positioned proximate that line to energise the boundary layer so as to mitigate stalling, as discussed above.

Typically, the VGs will be mounted on the suction side of the blade, as shown, although they could alternatively (or additionally) be mounted on the pressure side of the blade. (It should be noted that the terms “pressure side 15” and “suction side 16” as used herein refer to the opposite sides of the VG relative to the flow direction DF, and not to the pressure and suction sides of the blade.)

The vortex generators may be formed by extrusion or 3D printing or any other convenient technique, e.g. from plastics or metal or composite material, either individually or in a group. As shown in FIG. 1A, a single vortex generator 10 or a group of two or more vortex generators 10 (e.g. a mirror-symmetric pair, as illustrated) may be formed on (e.g. integrally with) a baseplate 50; the baseplate 50 can then be fixed to the blade so that the surface 8 of the baseplate 50 forms part of the blade surface 8. Alternatively, each vortex generator could be attached to the blade at its lower margin 11, using adhesive or mechanical fasteners or welding or brazing or any other suitable means as known in the art.

Referring to FIGS. 1-5, each vortex generator 10 has a lower margin 11, a stepped, upper margin 12, a leading end 13, a trailing end 14, and a length L in its length dimension between the leading end 13 and the trailing end 14. The VG 10 is connected to the blade at its lower margin 11 which is arranged at the blade surface 8 for at least a part of its length L. The lower margin 11 may be connected to the blade surface 8 along the whole length L of the VG; alternatively, the lower margin 11 may depart from the blade surface 8 proximate the trailing end 14 to form a notch (not shown) between the lower margin and the blade at the trailing end 14. The lower margin 11 may (but need not) be faired into the blade surface 8, in which case the fairing may be considered a part of the VG rather than a part of the blade.

The vortex generator 10 has two opposite sides which are designated as a pressure side 15 and a suction side 16 when the VG is mounted in the use position. Each of the pressure side 15 and the suction side 16 is bounded in the height dimension by the lower margin 11 and the upper margin 12 which forms the free edge of the VG.

It should be understood that the pressure side 15 and suction side 16 are defined by the orientation of the VG relative to the flow direction DF; thus, if the use position is undefined, either side can be the pressure side, for which reason the two sides 15, 16 are not identified as such in the unmounted views of FIGS. 5 and 6.

However, since the curvature of the surface 8 of a HAWT blade will vary depending on the size and profile and position on the blade, either the lower margin 11 or the baseplate 50 may be configured to mount the VG or the group of VGs in the target position on the blade (or the type of blade) for which they are made. For this reason, the intended use position and the flow direction DF, hence the identity of the pressure side 15 and suction side 16, will typically be defined when the VG is manufactured and before it is attached to the blade.

Referring to FIGS. 2B, 3B, and 4B, the VG has a thickness T in a thickness dimension between the pressure side 15 and the suction side 16. As illustrated, the VG may be generally lamellar with substantially the same thickness T (e.g. within about +/−20%, or +/−10%, or even +/−5% of an average value) over at least most of a total surface area of the suction side 16 and the pressure side 15, ignoring any fairing at the lower margin 11.

The VG may be formed as a thin plate connected at its thin edge to the blade surface 8. As illustrated, the thickness T over at least most of a total surface area of the suction side 16 and the pressure side 15 (ignoring any fairing at the lower margin 11) may be not more than 15% of the height H in the reference plane (e.g. reference plane P1 or P2 as illustrated).

Referring now to FIG. 1B, the concave-convex shape in the height dimension is defined in cross-section in a reference plane P1, P2 perpendicular to the blade surface 8 and proximate the trailing end 14. In the illustrated example, the VG 10 exhibits this shape in reference plane P1, which is very close to the trailing end 14, but the same shape can just be discerned in reference plane P2 which is further forward.

As illustrated, the concave-convex shape preferably extends forward from the trailing end 14 to at least one step 17 and then blends into a simpler shape towards the leading end 13, as further discussed below. In FIG. 1B the end view is aligned with the plan view, illustrating how the rearmost step 17 is located between the two reference planes P1, P2.

FIG. 2B shows the cross-section in reference plane P1 in which the concave-convex shape is more clearly evident. Referring to this section, the VG 10 defines an upper portion 22 terminating at the upper margin 12 (in the illustrated example, in-between the rearmost step 17 and the trailing edge 14). The VG also defines a lower portion 21 terminating at the lower margin 11, and an intermediate portion 20 between the upper and lower portions 22, 21.

The lower and intermediate portions 21, 20 define a lower convexity 23 opposite a lower concavity 23′, while the the upper and intermediate portions 22, 20 define an upper convexity 24 opposite an upper concavity 24′.

The upper and lower concavities 24′, 23′ open at different sides 15, 16 of the vortex generator 10, 10′, so that a pressure differential is generated between the air cushions formed within them.

In this specification, “concavity” and “convexity” do not necessarily imply a curved rather than angular shape. Preferably however, the shape is smoothly curved so that the three portions are blended where they meet to form a gentle, S-shaped curve.

Thus, preferably, and as illustrated, when considered in the reference plane P1 or P2, the upper portion 22, lower portion 21 and intermediate portion 20 are continuously curved to define a first inflection 25 in the intermediate portion 20, where the convexity blends into the concavity on each side of the VG.

As illustrated and best seen in FIG. 2B, the upper and lower portions 22, 21 may be more nearly perpendicular to the blade surface 8 than is the intermediate portion 20.

The VG is mounted on the blade in the use position with the leading end 13 upstream of the trailing end 14 in the flow direction DF, so that the VG extends in its length dimension oblique (i.e. at an acute angle) to the flow direction DF, with the pressure side 15 facing against the flow direction DF so that, in use, the flowing air impinges on the pressure side 15 and curls over the upper margin 12 as previously described. This rotating or overturning flow is enhanced by the pressure differential produced between the cushions of air lying in the two concavities on opposite sides of the VG, producing a vortex that penetrates the boundary layer close to the blade surface 8.

As illustrated in FIG. 2B, the upper concavity 24′ may open at the pressure side 15, while the lower concavity 23′ opens at the suction side 16. Alternatively, the upper concavity 24′ may open at the suction side 16, while the lower concavity 23′ opens at the pressure side 15. The oppositely directed concavities control the downstream trajectory of the vortex flow, keeping it close to the blade surface, and advantageously also provide enhanced vorticity with a relatively small penalty in parasitic drag.

As shown in FIGS. 2B, 3B, and 4B, the height H of the vortex generator is defined in the height dimension between the blade surface 8 and the upper margin 12 when mounted in the use position.

As best seen in FIGS. 1A-1C and FIG. 5, the upper margin 12 forming the free edge of the VG defines at least one step 17 which is spaced apart in the length dimension from the leading and trailing ends 13, 14, so that the height H increases stepwise at the or each step 17 towards the trailing end 14 in the length dimension. Each step 17 defines a relatively more steeply rising portion of the upper margin 12 compared with the relatively flat or less steeply rising portions 12′ in-between the steps.

As the air flows along the pressure side 15, each step interrupts the flow so that the flow curls over the upper margin 12 to initiate a vortex at the step 17. The vortex formed at the step 17 becomes entangled with the vortices formed at the leading and trailing ends 13, 14 and the other step or steps 17, if any. In tests it is found that the stepped free edge in combination with the oppositely directed concavities produces a family of bound vortices that is longer and more stable with a predictable trajectory which can effectively energise the boundary layer for most or all of the remaining width of the blade to the trailing edge 6.

Preferably, the upper concavity 24′ extends in the length dimension from the trailing end 14 to at least a rearmost one of the step or steps 17, and terminates where it intersects the upper margin 12 between the leading end 13 and the trailing end 14. In the illustrated example it can be seen that the concave-convex shape is barely discernible in the forward reference plane P2 (FIG. 1B, FIG. 3B) and disappears in-between that point and the third section line A-A (FIG. 1B, FIG. 4B).

Whereas the novel VG can suppress stalling and so increase lift, it also adds its own drag, which however is relatively small compared with the energy of the generated vortex flow.

Referring now to FIG. 1B, in order to reduce the drag induced by the VG, preferably the VG 10 is curved in the length dimension to define a second inflection 26 in-between the leading and trailing ends 13, 14, forming a gentle S-shaped curve in plan view. The VG extends away from the second inflection 26 towards each of the leading and trailing ends 13, 14 at an acute and progressively reducing angle of attack A1 relative to the flow direction DF. That is to say, the VG becomes progressively better aligned with the flow direction DF towards its two ends, while its mid-portion at the inflection 26 is maximally slanted to the flow to induce the overturning airflow that forms the vortex at the or each step.

In use, it is found that the family of bound vortices will follow the plan S-shaped curve and stream away from the trailing edge 14 along the flow direction DF.

The upper margin may define one step, two steps, or three steps 17 as illustrated. For optimal performance it is preferred that the upper margin 12 defines not more than three steps 17, since a greater number is found to produce weaker vorticity.

The novel vortex generator is applied to the proximal end region of the blade (e.g. up to about 40% of the length of the blade from the root), rather than the distal end region towards the tip, since vortex generators as applied to the radially outward, distal end region of the blade will typically have a much smaller height which is insufficient to accommodate effective steps.

Referring again to FIG. 1B, a pair of VGs may be mirror-symmetric about a plane of symmetry S1 so that they either diverge (as shown) or converge in the flow direction DF.

It can be seen that when considered in plan view as projected onto the blade surface 8, as shown in the plan view of FIG. 1B, the upper and lower margins 12, 11 are mutually offset along the blade length axis XL so that, in a mirror-symmetric pair of VGs, the upper margins 12 will lie either inwardly (as shown) or outwardly of the outer margins 11, depending on the orientation of the concave/convex features of each VG.

A divergent pair (as shown) will generate a lower pressure in-between the pair and so enhance the pressure differential across the outer (pressure) sides 15 to the inner (suction) sides 16, which creates stronger vorticity. A convergent pair will similarly generate an enhanced higher pressure in-between the pair, producing a synergistic effect where adjacent ones of an array of VGs are arranged to form pairs which are alternately convergent and divergent in the flow direction, so that the resulting vortices are advantageously closer together and closer to the blade surface 8.

This arrangement is shown in FIGS. 8A and 8B where a first group 30 of VGs 10 are spaced apart along the blade length axis XL (which is to say, along the length direction of the blade) to form pairs 31 and 32. When considered along the blade length axis XL, each VG is a member of two pairs of adjacent VGs, one pair 31 being convergent and the adjacent pair 32 being divergent in the flow direction DF.

The length L of each VG 10 of the first group 30, when measured parallel with the flow direction DF, may be from 0.5% to 2.0% of the length of the chord of the aerofoil profile proximate the respective VG.

Each pair may be mirror-symmetric about a plane of symmetry S1 as shown in FIG. 1B. As discussed above, the VGs 10 of the first group 30 are arranged proximate the point at which the airflow would otherwise detach from the blade surface if the VGs were not present. By way of example, the leading end 13 of the VG 10 may be positioned from about 5% to 70% of the length of the chord 7 from the leading edge 5 of the aerofoil.

In an alternative arrangement, rather than arranging adjacent VGs in convergent/divergent pairs, the VGs may be spaced apart along the blade so that the pressure sides 15 of respective adjacent ones of the VGs face in the same direction of the blade length axis XL. That is to say, the VGs are generally parallel and all slanted oblique to the flow direction DF in the same direction of the blade length axis XL.

This arrangement can be seen in the second group 40 of VGs as shown in FIGS. 8A and 8B. As can be seen in FIG. 6, the VGs 10′ of the second group 40 are generally the same as the first VGs 10, except for their relatively larger dimensions. In the illustrated example, the pressure side 15 of each VG 10′ faces outwardly towards the blade tip, but could alternatively be arranged to face inwardly towards the blade root.

The length L of each VG 10′ of the second group 40, when measured parallel with the flow direction DF (which is to say, along the direction of the chord 7), may be from 0.5% to 3% of the length of the chord 7 of the aerofoil profile proximate the respective VG.

In this generally parallel arrangement, the VGs 10′ of the second group 40 help to suppress undesirable radial flow along the blade length axis XL towards the blade tip 3. For this purpose, although the VGs 10′ as illustrated have an inflection mid-way between their leading and trailing ends, similar to the inflection 26 of the first VGs 10, they could alternatively be curved without inflection in the length dimension.

Although the first and second groups 30, 40 are shown in combination, they could be applied separately to the blade.

By way of example, the VG 10 may have a length L from about 25 mm to 200 mm (measured parallel with the flow direction DF), and a maximum height H from about 10 mm to 75 mm at the trailing end 14. For example, it could be around 80 mm-90 mm in length and around 30 mm in height at the trailing end 14. The length L may be from around 0.5% to 2.0% of the chord length (i.e. the length of the chord 7 from the leading edge 5 to the trailing edge 6 of the aerofoil profile.)

By way of example, when arranged in a generally parallel configuration for suppressing radial flow, the VG 10′ may have a length L from about 100 mm to 500 mm (measured parallel with the flow direction DF) and a maximum height H from about 50 mm to 150 mm (so, an aspect ratio defining a relatively longer, lower profile than the VG 10.)

In summary, a vortex generator 10, 10′ is arranged oblique to the flow direction DF on the surface 8 of the radially inward portion 1 of a HAWT rotor blade. The vortex generator has an upwardly stepped free edge 12 and defines, proximate its trailing end 14, a lower convexity 23 opposite a lower concavity 23′, and an upper convexity 24 opposite an upper concavity 24′. The upper and lower concavities 24′, 23′ open at opposite sides 15, 16 of the vortex generator.

Many further adaptations are possible within the scope of the claims.

In the claims, reference numerals and characters are provided in parentheses, purely for ease of reference, and should not be construed as limiting features.

1. A vortex generator (10, 10′) configured to be mounted in a use position on a wind turbine blade (1, 2);
the blade (1,2) having a blade length axis (XL) and a blade surface (8), wherein, in use, air flows over the blade surface in a flow direction (DF) perpendicular to the blade length axis (XL);
the vortex generator (10, 10′) having:
a lower margin (11), an upper margin (12), and a height (H) in a height dimension between the blade surface (8) and the upper margin (12) when mounted in the use position;
a leading end (13), a trailing end (14), and a length (L) in a length dimension between the leading end (13) and the trailing end (14); and
a pressure side (15), a suction side (16) opposite the pressure side (15), and a thickness (T) in a thickness dimension between the pressure side (15) and the suction side (16), each of the pressure side (15) and the suction side (16) being bounded in the height dimension by the lower margin (11) and the upper margin (12);
wherein, when mounted in the use position:
the leading end (13) is upstream of the trailing end (14) in the flow direction; and
the lower margin (11) is arranged at the blade surface (8) for at least a part of the length (L); and
the vortex generator (10, 10′) extends in the length dimension oblique to the flow direction (DF) with the pressure side (15) facing against the flow direction (DF) so that, in use, the flowing air impinges on the pressure side (15); and
the upper margin (12) defines at least one step (17) spaced apart in the length dimension from the leading and trailing ends (13, 14), the height (H) increasing stepwise at the or each step (17) towards the trailing end (14) in the length dimension; and,
when considered in cross-section in a reference plane (P1, P2) perpendicular to the blade surface (8) and proximate the trailing end (14), the vortex generator (10, 10′) defines an upper portion (22) terminating at the upper margin (12), a lower portion (21) terminating at the lower margin (11), and an intermediate portion (20) between the upper and lower portions (22, 21);
the lower and intermediate portions (21, 20) defining a lower convexity (23) opposite a lower concavity (23′);
the upper and intermediate portions (22, 20) defining an upper convexity (24) opposite an upper concavity (24′);
the upper and lower concavities (24′, 23′) opening at different sides (15, 16) of the vortex generator (10, 10′).

2. A vortex generator (10, 10′) according to claim 1, wherein the upper concavity (24′) opens at the suction side (16), and the lower concavity (23′) opens at the pressure side (15).

3. A vortex generator (10, 10′) according to claim 1, wherein the upper concavity (24′) opens at the pressure side (15), and the lower concavity (23′) opens at the suction side (16).

4. A vortex generator (10, 10′) according to claim 1, wherein, when considered in the reference plane (P1, P2), the upper portion (22), lower portion (21) and intermediate portion (20) are continuously curved to define a first inflection (25) in the intermediate portion (20).

5. A vortex generator (10, 10′) according to claim 1, wherein the upper concavity (24′) extends in the length dimension from the trailing end (14) to at least one said step (17), and terminates at the upper margin (12) between the leading end (13) and the trailing end (14).

6. A vortex generator (10, 10′) according to claim 1, wherein the upper and lower portions (22, 21) are more nearly perpendicular to the blade surface (8) than is the intermediate portion (20).

7. A vortex generator (10, 10′) according to claim 1, wherein the upper margin (12) defines not more than three said steps (17).

8. A vortex generator (10, 10′) according to claim 1, wherein the vortex generator (10, 10′) is curved in the length dimension to define a second inflection (26) in-between the leading and trailing ends (13, 14), and extends away from the second inflection (26) towards each of the leading and trailing ends (13, 14) at an acute and progressively reducing angle of attack (A1) relative to the flow direction (DF).

9. A vortex generator according to claim 1, wherein the vortex generator is curved without inflection in the length dimension.

10. A vortex generator (10, 10′) according to claim 1, wherein the vortex generator (10, 10′) has substantially the same thickness (T) over at least most of a total surface area of the suction side (16) and the pressure side (15).

11. A vortex generator (10, 10′) according to claim 1, wherein, over at least most of a total surface area of the suction side (16) and the pressure side (15), the thickness (T) is not more than 15% of the height (H) in the reference plane (P1, P2).

12. A blade (1, 2) for a rotor of a horizontal axis wind turbine, the rotor being configured to rotate in use about a rotor axis (XR);
the blade (1, 2) having a blade length axis (XL) and a blade surface (8) and defining an aerofoil profile configured to generate lift when air flows over the blade surface (8) in a flow direction (DF) perpendicular to the blade length axis (XL);
the blade (1, 2) extending in use radially outwardly from the rotor axis (XR) along the blade length axis (XL), from a proximal end region (1) terminating at a blade root (9) to a distal end region (2) terminating at a blade tip (3);
the proximal end region (1) including a plurality of vortex generators (10, 10′) according to claim 1,
the vortex generators (10, 10′) being mounted in the use position and spaced apart along the blade length axis (XL).

13. A blade (1, 2) according to claim 12, wherein the plurality of vortex generators (10, 10′) include a first group (30) of vortex generators (10); wherein, when considered along the blade length axis (XL), adjacent ones of the vortex generators (10) of the first group (30) form pairs (31, 32) which are alternately convergent (31) and divergent (32) in the flow direction (DF).

14. A blade (1, 2) according to claim 13, wherein the length (L) of each of said adjacent ones of the vortex generators (10) of the first group (30), when measured parallel with the flow direction (DF), is from 0.5% to 2.0% of a chord length (7) of the aerofoil profile proximate the respective one of the vortex generators.

15. A blade (1, 2) according to claim 12, wherein the plurality of vortex generators (10, 10′) include a second group (40) of vortex generators (10′); wherein the pressure sides (15) of respective adjacent ones of the vortex generators (10′) of the second group (40) face in the same direction of the blade length axis (XL).

16. A blade according to claim 15, wherein the length (L) of each of said respective adjacent ones of the vortex generators (10′) of the second group (40), when measured parallel with the flow direction (DF), is from 0.5% to 3% of a chord length (7) of the aerofoil profile proximate the respective one of the vortex generators.
